(19) United States
(12) Patent Application Publication
(10) Pub. No.: US 2011/0140805 A1
(43) Pub. Date: Jun. 16, 2011

(54) PHASE SHIFTER

(75) Inventors: Nian-Qiang Liu, Hsinchu City (TW); Peng Chen, Hsinchu City (TW); Xiao Huang, Hsinchu City (TW)

(73) Assignee: WHA YU INDUSTRIAL Co., Ltd., Hsinchu City (TW)

(21) Appl. No.: 12/639,522

(22) Filed: Dec. 16, 2009

(51) Int. Cl. H01P 1/18

(52) U.S. Cl. 333/161

(57) ABSTRACT

A phase shifter having a chamber in flat-shaped solid state, one side of which is recessed to form a holding space, and a lower coupling circuit board, assembled into the holding space. The lower coupling surface of the lower coupling circuit board is fitted with two coupling strips arranged at interval. One end of the coupling strips is provided with a cable coupling portion. An upper coupling strip is overlapped onto the lower coupling circuit board in a U-shaped pattern. The upper coupling strip is provided with an upper coupling surface for coupling with the coupling strips of the lower coupling circuit board. A slider has a driving end and a driven end, the driving end being used to connect and drive the upper coupling strip, and the driven end protrudes out of the chamber's holding space. A cover plate is used to seal the chamber's holding space.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a phase shifter, and more particularly to an innovative one which permits the driving mechanism to be overlapped into a platy pattern.

2. Description of Related Art Including Information Disclosed Under 37 CFR 1.97 and 37 CFR 1.98

Due to sharp increase of end users for mobile communication system, many base stations are under full-load state, especially in urban areas where the user distribution is characterized by bigger density and time-dependent change. For instance, the distribution of terminal equipments of mobile phones and PDS, etc, changes markedly at different working hours or on holidays in the industrial and commercial parks, the load of base stations previously covering these regions may be prone to volatility, lower availability, leading to degrading of QoS and waste of resources.

In response to the aforementioned problems and requirements, an electric antenna is extensively used in communication base stations in lieu of conventional antenna. The electric antenna permits to regulate its radiation angle depending on the coverage range, traffic and disturbance of the mobile network, so as to optimize the communication network, maximize the quality of service and promote the availability of resources.

The core element of said electric antenna is a phase shifter to be improved by the present invention; yet, some shortcomings of conventional phase shifter are still observed from its structural configuration, e.g.: as for the big-sized phase shifter which enables regulations of parts by mating the coaxial tubes with the transmission lines(such as: U.S. Pat. No. 2,502,359), the cross-sectional volume of the phase shifter will be enlarged, leading to numerous waste of space, inconvenient processing & assembly and higher manufacturing cost, etc.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

Based on the unique configuration of the “phase shifter” of the present invention that the internal driving members mainly comprise the lower coupling circuit board, the upper coupling strip and the slider, the overlapped platy pattern enables to reduce the structural space, cut down the manufacturing/assembly cost and enhance the performance with improved practicability and economic benefits.

The improvements brought about by this invention are as follow:

Based on the structural configuration wherein elastic members are arranged between the compression spacer and the cover plate, the elastic members are used to press elastically the compression spacer towards the upper coupling strip into an elastic compression state. With this structural configuration, even if wearing or deformation may occur between the upper coupling strip and the lower coupling circuit board, the elastic members can be employed to maintain the consistent and stable coupling state, thereby improving the quality of phase shifter and extending its service life.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the present invention in an assembled state.

FIG. 2 shows an exploded perspective view of the present invention.

FIG. 3 shows a top view of internal structure of the present invention.

FIG. 4 shows a cross sectional view of internal structure of the present invention.

FIG. 5 shows a cross sectional view of internal structure of the present invention viewed from another sectional angle.

FIG. 6 shows a schematic view of the operating state of the slider of the present invention.

FIG. 7 shows an exploded perspective view of another preferred embodiment of the present invention.

FIG. 8 shows a cross sectional view of another preferred embodiment of the present invention.

FIG. 9 shows a cross sectional view of a preferred embodiment of the present invention that a pressing locator is formed on the cover plate.

FIG. 10 shows a cross sectional view of a preferred embodiment of the present invention that the upper coupling strip is sealed by the cover plate.

### DETAILED DESCRIPTION OF THE INVENTION

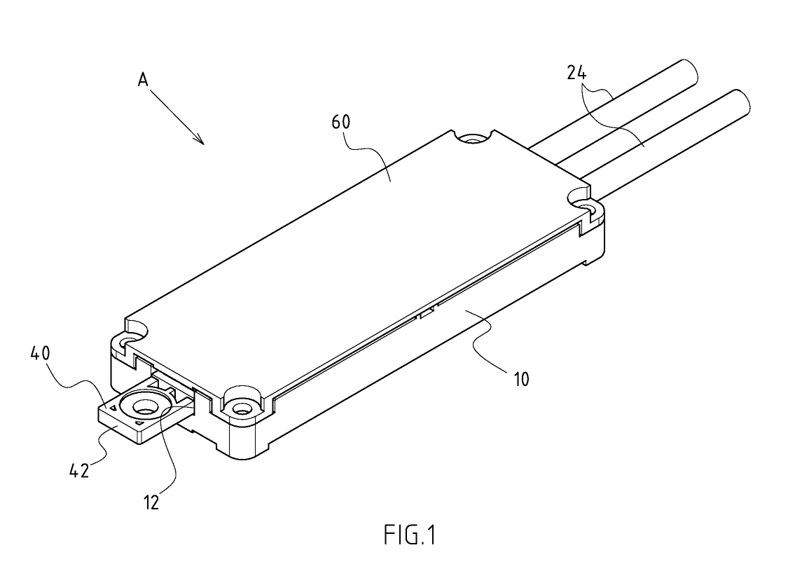

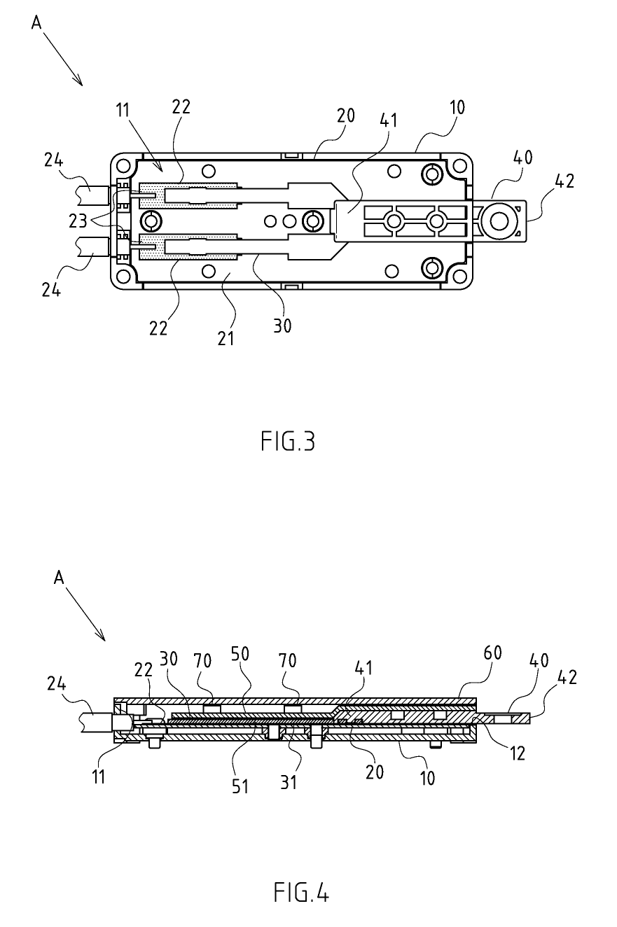

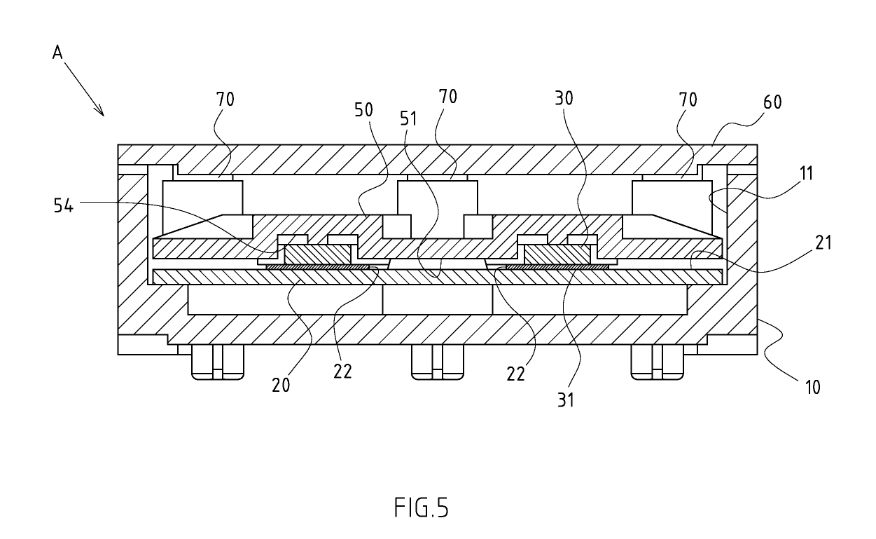

FIGS. 1-5 depict preferred embodiments of a phase shifter of the present invention, which are provided for only explanatory objective for patent claims. The phase shifter A includes a chamber 10 in a flat-shaped solid state, which is formed by metal die-casting and surface coating. One side of the chamber 10 is recessed to form a holding space 11. A slider through-hole 12 and a cable through-hole 13 are separately arranged at both ends of the holding space 11.

A lower coupling circuit board 20 is made of double-layer PCB board, which is assembled into the holding space 11 of the chamber 10. The lower coupling circuit board 20 is provided with a lower coupling surface 21, which is fitted with long-shaped two coupling strips 22 arranged at interval. One end of the two coupling strips 22 is provided with a cable coupling portion 23 aligned with the cable through-hole 13 of the holding space 11. The cable coupling portion 23 is used for coupling with the cable 24, and allowing the cable 24 to penetrate the cable through-hole 13.

An upper coupling strip 30 is a brass strip with insulating coatings. The upper coupling strip 30 is overlapped onto the lower coupling circuit board 20 in the form of a U-shaped plate. An upper coupling surface 31 is placed on the bottom of the upper coupling strip 30 for coupling with two coupling strips 22 on the lower coupling surface 21 of the lower coupling circuit board 20.

A slider 40 is made of molded plastic parts, comprising a driving end 41 and a driven end 42; the driving end 41 is used to connect and drive the upper coupling strip 30, and the driven end 42 protrudes out of the slider through-hole 12 set onto the holding space 11 of the chamber 10.

A compression spacer 50 is made of molded plastic sheet, comprising a pressing surface 51 that's used to press the upper coupling strip 30. The upper coupling strip 30 and lower coupling circuit board 20 are allowed to keep a stable coupling state for stable regulation and operation.

A cover plate 60 is used to cover the holding space 11 of the chamber 10, and also conceal the lower coupling circuit board 20, upper coupling strip 30, slider 40 and compression spacer 50.

Of which, a plurality of elastic members 70 is arranged between the compression spacer 50 and the cover plate 60, and used to press elastically the compression spacer 50 towards the upper coupling strip 30 into an elastic compression state. With this structural configuration, even if wearing or deformation may occur between the upper coupling strip 30 and the lower coupling circuit board 20, the elastic members 70 can be employed to maintain the consistent and stable coupling state, thereby improving the quality of phase shifter and extending its service life.

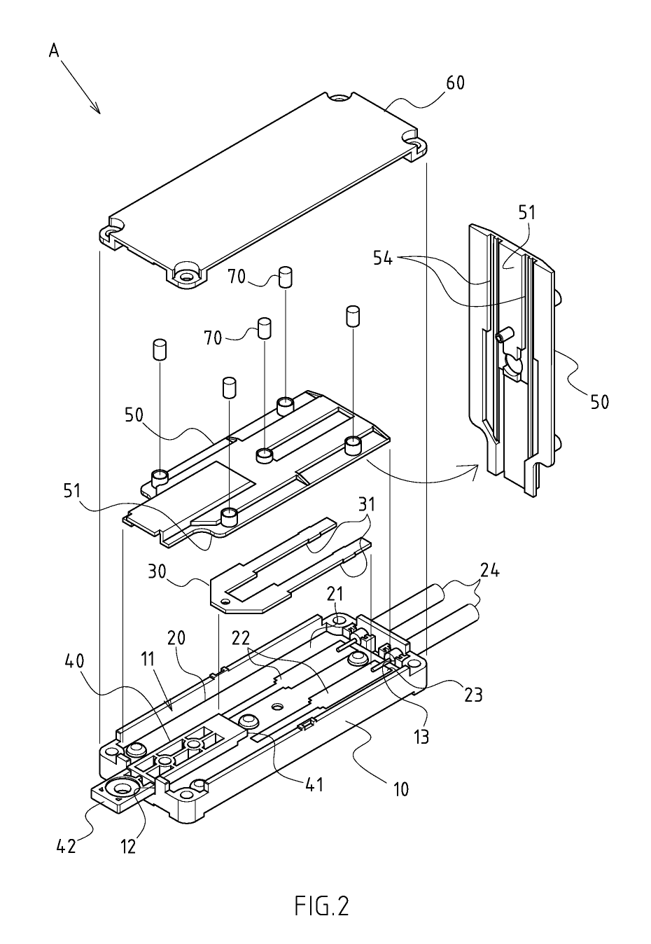

Referring to FIGS. 2 and 5, the recessed space 54 is set on the pressing surface 51 of the compression spacer 50 for embedding of the upper coupling strip 30.

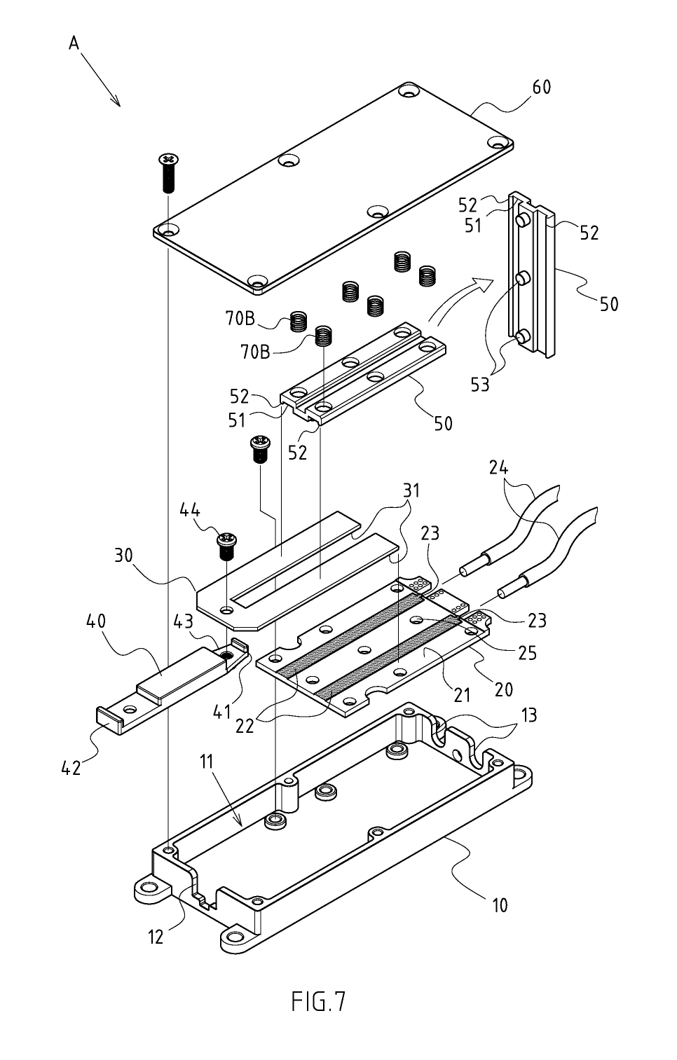

Referring to FIG. 7, a groove 43 is also set on the driving end 41 of the slider 40 for embedding of one end of the upper coupling strip 30, and then fixation by a bolt 44.

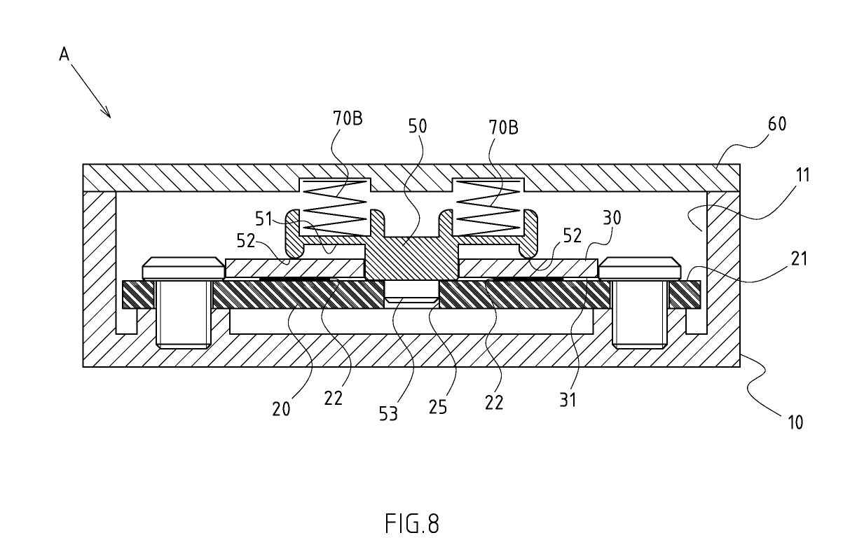

Referring to FIGS. 7 and 8, two long pressing strips 52 are arranged in parallel onto the pressing surface 51 of the compression spacer 50, along with a plurality of locating bosses 53 set between two pressing strip 52. These two pressing strips 52 are used to contact the upper coupling strip 30. Moreover, the lower coupling circuit board 20 is provided with a plurality of embedding holes 25, allowing to insert and position the locating boss 53 of the compression spacer 50 (shown in FIG. 8).

Based on the above-specified structural configuration, the present invention is operated as follows:

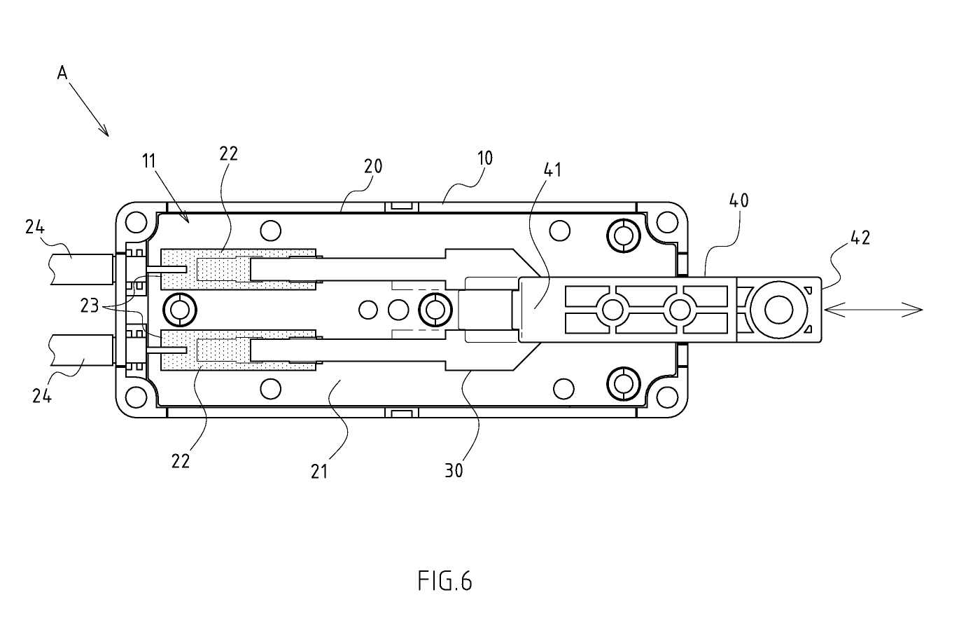

Referring to FIG. 6, said phase shifter A is operated in such a manner that the displacement of the slider 40 (indicated by arrow L1) could drive the simultaneous shift of upper coupling strip 30. With the structural configuration of U-shaped upper coupling strip 30, the electric transmission between two cable coupling portions 23 will become longer when the upper coupling strip 30 shifts towards the slider 40. Otherwise, the electric transmission between two cable coupling portions 23 will become shorter when the upper coupling strip 30 shifts towards the cable coupling portion 23. This enables the phase shifter A to realize phase shift of the transmission signals. On the other hand, during the displacement of the upper coupling strip 30, the compression spacer 50 enables the upper coupling strip 30 and the lower coupling circuit board 20 to maintain a stable coupling state. It is more worthy to note that, as the lower coupling circuit board 20, upper coupling strip 30 and compression spacer 50 are fabricated into platy pattern, the space and thickness required for the phase shifter A can be minimized to the extent possible, and the overlapped pattern allows to assemble them easily and improve the manufacturing efficiency substantially. Furthermore, such a platy design could save the manufacturing materials and provide excellent manufacturing process and yields in terms of punching, cutting or injection molding.

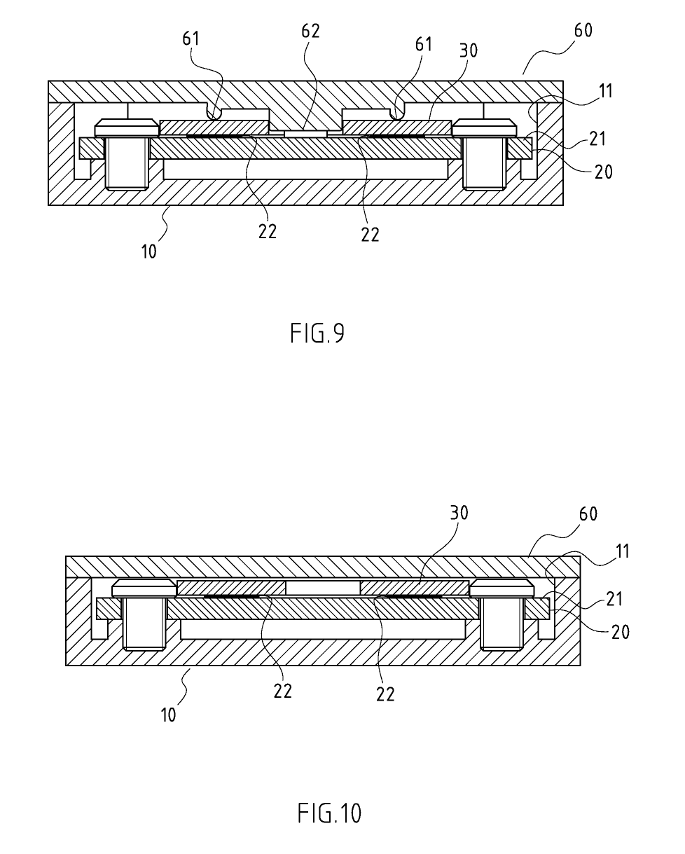

Referring to FIG. 9, a pressing locator 61 (a bulging) is protruded downwards at the bottom of the cover plate 60 by means of prefabrication or assembly, and used to press the upper coupling strip 30 for limitation purpose. Furthermore, the pressing locator 61 is fitted with a guiding portion 62 (a lug) for linear stable guiding of the upper coupling strip 30.

Referring also to FIG. 10, the upper coupling strip 30 can also be sealed into the holding space 11 of the chamber 10 via the cover plate 60.

Of which, the elastic members 70 can be made of either of the following materials: Polyurethane (PU), elastic plastics like rubber (shown in FIG. 2). Alternatively referring to FIGS. 7, 8, the elastic members 70B is made of spring.

Additionally, the pattern or dimension of the upper coupling strip 30 and the coupling strips 22 on the lower coupling surface 21 of the lower coupling circuit board 20 can be adjusted flexibly depending on the actual resistance match value of the coupling circuit.

1. A phase shifter, comprising:
a chamber, one side of which is recessed to form a holding space;
a lower coupling circuit board, assembled into the holding space of the chamber, the lower coupling circuit board is provided with a lower coupling surface, which is fitted with long-shaped two coupling strips arranged at interval one end of the two coupling strips is provided with a cable coupling portion;
an upper coupling strip, overlapped onto the lower coupling circuit board, the upper coupling strip is provided with an upper coupling surface for coupling with two coupling strips on the lower coupling surface of the lower coupling circuit board;
a slider having a driving end and a driven end; the driving end is used to connect and drive the upper coupling strip, and the driven end protrudes out of the holding space of the chamber; and
a cover plate, used to cover the holding space of the chamber, and also to conceal the lower coupling circuit board, upper coupling strip and slider.

2. The structure defined in claim 1, wherein a groove is set on the driving end of said slider for embedding of one end of the upper coupling strip, and then fixation by a bolt.

3. The structure defined in claim 1, wherein a compression spacer is assembled internally onto the cover plate of the chamber, said compression spacer having a pressing surface that is used to press the upper coupling strip; the upper coupling strip and lower coupling circuit board are allowed to keep a stable coupling state.

4. The structure defined in claim 3, wherein elastic members are arranged between the compression spacer and the cover plate, and used to press elastically the compression spacer towards the upper coupling strip into an elastic compression state.

5. The structure defined in claim 4, wherein the elastic members are made of either of the following materials: Polyurethane (PU), elastic plastics like rubber or spring.

6. The structure defined in claim 3, wherein pressing strips are arranged in parallel onto the pressing surface of the compression spacer, along with a plurality of locating bosses set between two pressing strip, said pressing strips are used to contact the upper coupling strip; moreover, the lower coupling circuit board is provided with a plurality of embedding holes, allowing to insert and position the locating boss of the compression spacer.

7. The structure defined in claim 3, wherein a recessed space is set on the pressing surface of the compression spacer for embedding of the upper coupling strip.

8. The structure defined in claim 1, wherein the cover plate is fitted with a pressing locator to press the upper coupling strip.

9. The structure defined in claim 8, wherein the pressing locator is protruded onto the cover plate by means of prefabrication or assembly.

10. The structure defined in claim 8, wherein the pressing locator is fitted with a guiding portion for guiding of the upper coupling strip.

11. The structure defined in claim 1, wherein the upper coupling strip is sealed by the cover plate.

12. The structure defined in claim 1, wherein a slider through-hole and a cable through-hole are separately arranged at both ends of the holding space of the chamber so the cable coupling portion of the coupling strips aligns with the cable through-hole, and the slider is driven end protrudes out of the slider through-hole.

13. The structure defined in claim 1, wherein the upper coupling strip is configured into a U-shaped plate.

14. The structure defined in claim 1, wherein the pattern or dimension of the upper coupling strip and the coupling strips on the lower coupling surface of the lower coupling circuit board can be adjusted flexibly depending on the actual resistance match value of the coupling circuit.
